(19) United States
(12) Patent Application Publication
(10) Pub. No.: US 2025/0301335 A1
(43) Pub. Date: Sep. 25, 2025

(54) MOBILE DEVICE ASSISTED GUIDANCE ACROSS CELLULAR WHITESPACE REGION

(71) Applicant: AT&T Intellectual Property I, L.P., Atlanta, GA (US)

(72) Inventors: Hongyan Lei, Plano, TX (US); Yupeng Jia, South Pasadena, CA (US)

(73) Assignee: AT&T Intellectual Property I, L.P., Atlanta, GA (US)

(21) Appl. No.: 18/610,479

(22) Filed: Mar. 20, 2024

(51) Int. Cl. H04W 24/02; H04B 7/185; H04W 16/18

(52) U.S. Cl. CPC H04W 24/02; H04B 7/18513; H04W 16/18

(57) ABSTRACT

Aspects of the subject disclosure may include, for example, determining a mobile device is near a boundary of a first coverage region of a first mobile service provided by one of a terrestrial mobile service and a non-terrestrial mobile service. A location is identified of second coverage region of a second mobile service provided by an alternative one of the terrestrial mobile service and the non-terrestrial mobile service, wherein the second coverage region is nearby the first coverage region. Persistent information is forwarded to the mobile device via the first mobile service, wherein the persistent information identifies a location of the second coverage region, and wherein the persistent information facilitates guidance of the mobile device toward the second coverage region. Other embodiments are disclosed.

### FIELD OF THE DISCLOSURE

The subject disclosure relates to mobile device assisted guidance across cellular whitespace region.

### BACKGROUND

Direct cellular to satellite communication provides a complementary service to extend cellular coverage to regions beyond those reachable by terrestrial base stations of a terrestrial network. An interworking between terrestrial cellular networks and satellite communication networks offering direct satellite to user equipment (UE) service facilitates secure exchanges of data with mobile service subscribers to better serve the needs of business, governments and out-of-reach consumers.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a whitespace guidance system functioning within the communication network of FIG. 1 in accordance with various aspects described herein.

FIG. 2B is a block diagram illustrating an example, non-limiting embodiment of a mobile device configured according to a whitespace guidance system functioning within the communication network of FIG. 1 in accordance with various aspects described herein.

FIG. 2C is a block diagram illustrating an example, non-limiting embodiment of another mobile device configured according to a whitespace guidance system functioning within the communication network of FIG. 1 in accordance with various aspects described herein.

FIG. 2D is a block diagram illustrating an example, non-limiting embodiment of a mobile device scenario according to a whitespace guidance system functioning within the communication network of FIG. 1 in accordance with various aspects described herein.

FIG. 2E is a block diagram illustrating an example, non-limiting embodiment of another mobile device scenario operating according to a whitespace guidance system functioning within the communication network of FIG. 1 in accordance with various aspects described herein.

FIG. 2F is a block diagram illustrating an example, non-limiting embodiment of yet another mobile device scenario operating according to a whitespace guidance system functioning within the communication network of FIG. 1 in accordance with various aspects described herein.

FIG. 2G depicts an illustrative embodiment of a mobile whitespace guidance process in accordance with various aspects described herein.

FIG. 2H depicts an illustrative embodiment of a mobile whitespace guidance process in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for determining that a mobile device is proximate to a boundary of a first region of a first type of cellular service, identify a location of second region of a second type of cellular service that may be separated from the first region by a whitespace region offering neither type of cellular service, and forwarded persistent information to the mobile device via the first type of cellular service. The persistent information identifies a location of the second coverage region and facilitates guidance of the mobile device toward the second coverage region, even when present within the whitespace region. Other embodiments are described in the subject disclosure.

One or more aspects of the subject disclosure include a process, which includes detecting, by a processing system including a processor, a cellular communication device approaching a boundary of a first coverage region of a first cellular service provided by one of a terrestrial cellular service and a non-terrestrial cellular service. According to the process, a second coverage region is identified, by the processing system, of a second cellular service provided by an alternative one of the terrestrial cellular service and the non-terrestrial cellular service, wherein the second coverage region is proximate to the first coverage region. Persistent information is transmitted, by the processing system, to the cellular communication device via the first cellular service, wherein the persistent information identifies a location of the second coverage region, and wherein the persistent information enables guidance of the cellular communication device in areas beyond the first coverage region.

One or more aspects of the subject disclosure include a device, including a processing system including a processor and a memory that stores executable instructions that, when executed by the processing system, facilitate performance of operations. The operations include estimating a wireless communication device is approaching a boundary of a first coverage region of a first wireless service provided by one of a terrestrial wireless service and a non-terrestrial wireless service. The operations further include identifying a second coverage region of a second wireless service provided by an alternative one of the terrestrial wireless service and the non-terrestrial wireless service, wherein the second coverage region is proximate to the first coverage region. Persistent information is forwarded to the wireless communication device via the first wireless service, wherein the persistent information identifies a location of the second coverage region, and wherein the persistent information enables guidance of the wireless communication device in areas beyond the first coverage region.

One or more aspects of the subject disclosure include a non-transitory, machine-readable medium, including executable instructions that, when executed by a processing system including a processor, facilitate performance of operations. The operations include determining a mobile device is proximate to a boundary of a first coverage region of a first mobile service provided by one of a terrestrial mobile service and a non-terrestrial mobile service. The operations further include identifying a location of second coverage region of a second mobile service provided by an alternative one of the terrestrial mobile service and the non-terrestrial mobile service, wherein the second coverage region is proximate to the first coverage region. Persistent information is forwarded to the mobile device via the first mobile service, wherein the persistent information identifies a location of the second coverage region, and wherein the persistent information facilitates guidance of the mobile device toward the second coverage region.

Satellite beams are typically on the order of about 1 to a few km wide. Accordingly, there may be issues in applying a supplemental satellite coverage due to overlap between satellite and terrestrial cellular networks reusing the same cellular spectrum. In at least some embodiments, the satellite beam may be directed, sized and/or positioned to avoid overlap with a terrestrial cellular network. This generally results in some distance and/or space between coverage areas of the satellite beams and the terrestrial cellular network, resulting in coverage holes, sometime referred to as whitespace.

The novel techniques disclosed herein address managing cellular consumers in whitespace regions by providing indications to the consumers when they find themselves in and/or transiting the whitespace regions. The indications may be adapted to assist the cellular consumer in finding connectivity. Alternatively, or in addition, whitespace regions may be narrowed, e.g., to some minimum achievable separation distance or gap between the different cellular services to avoid interference.

Satellite coverage edge beams and/or coverage edge gNBs, e.g., cell clusters, may be distinguished to facilitate identifying and/or indicating that wireless communication device, e.g., user equipment (UE), is present within and/or approaching an edge of coverage, sometimes referred to as a “last mile.” According to the novel techniques disclosed herein, cellular network base stations at an edge of coverage region may receive, generate and/or provide one or more information elements (IE) configured to indicate to UE devices that there are no cellular cells toward a particular direction, e.g., a direction of movement of the UE, indicating that the UE may be heading into whitespace areas without cellular coverage. Accordingly, a detection and/or other indication may be determined and/or otherwise provided indicating that a UE device is leaving a region of terrestrial cellular coverage.

Further according to the novel techniques disclosed herein, satellite communication system controlling spot beams at an edge of coverage region may receive, generate and/or provide one or more IEs configured to indicate to UE devices that there are no satellite spot beams toward a particular direction, e.g., a direction of movement of the UE, indicating that the UE may be heading into whitespace areas without cellular coverage. Accordingly, a detection and/or other indication may be determined and/or otherwise provided indicating that a UE device is leaving a region of satellite cellular coverage, e.g., there are no neighboring satellite beams ahead towards directions the users are driving or walking.

The novel techniques disclosed herein include preparation of guidance information, e.g., directions, to next available terrestrial cell and/or satellite beam. In at least some embodiments, artificial intelligence (AI), e.g., generative AI, may be applied to any one or more of the various techniques disclosed herein. For example, the AI may be used to predict a direction the users are moving toward. Alternatively, or in addition, generative AI may be applied to predict one or more of a direction, distance to and/or estimated time of arrival (ETA) at a next connectivity availability. It is envisioned further, that in at least some embodiments, AI, including generative AI may be applied to dynamically to guide UE devices toward connectivity. In at least some embodiments, the AI-generated direction may be presented in a “North star” manner, similar to a compass, at a graphical user interface of the UE device. The AI-generated direction presented on UE devices may include one or more of an arrow, a picture, an avatar, animation, and so on.

In at least some embodiments, generative AI may be adapted to detect movement of a UE device as may include a walking and/or driving direction, which, in combination with storage of an offline map, may be processed, e.g., by an application program or app at the UE alone or in combination with AI, to facilitate generation of a recent past trajectory and predict and/or otherwise estimate future trajectory for at least a distance sufficient to encounter a different cellular service, e.g., measured in miles based on prediction of moving direction. UE devices may to receive and/or generate related notifications and/or guidance directions, even while in idle mode, e.g., similar to an amber alert, if they UE device is present within some threshold distance to the coverage edge. Such early notifications provide users with an opportunity to rethink next steps and get better prepared for managing cellular service.

In at least some embodiments, satellite spot beams may overlap terrestrial cells along fringe areas to reduce and/or eliminate whitespace regions. In an effort to reduce interference, such applications may apply a reduced bandwidth, e.g., low density, paging to maximize the connectivity opportunities. Such coordination and bandwidth tailoring facilitates a sharing of reserved, e.g., licensed, cellular bands with satellite communication systems, while reducing and/or otherwise minimizing impact to terrestrial cellular service operating within the reserved cellular bands.

By way of example, generative AI may predict the existence of cellular base stations along a trajectory of a satellite moving course. A satellite beam, e.g., a spot beam, may be positioned adjacent to and/or slightly overlapping a terrestrial cell. Cellular service provided by the spot beam may be configured to use a reduced bandwidth (or density) paging in overlapping areas to maximize connectivity opportunities. Such coordination allows the satellite spot beam to share the same reserved cellular band, while doing so with minimum impact to cellular band. In at least some instances, the benefit is similar to LTE-5G dynamic spectrum sharing.

Maximize reliable connectivity in regions without traditional network infrastructure, making it valuable for various applications like maritime, aviation emergency rescue and remove field operations.

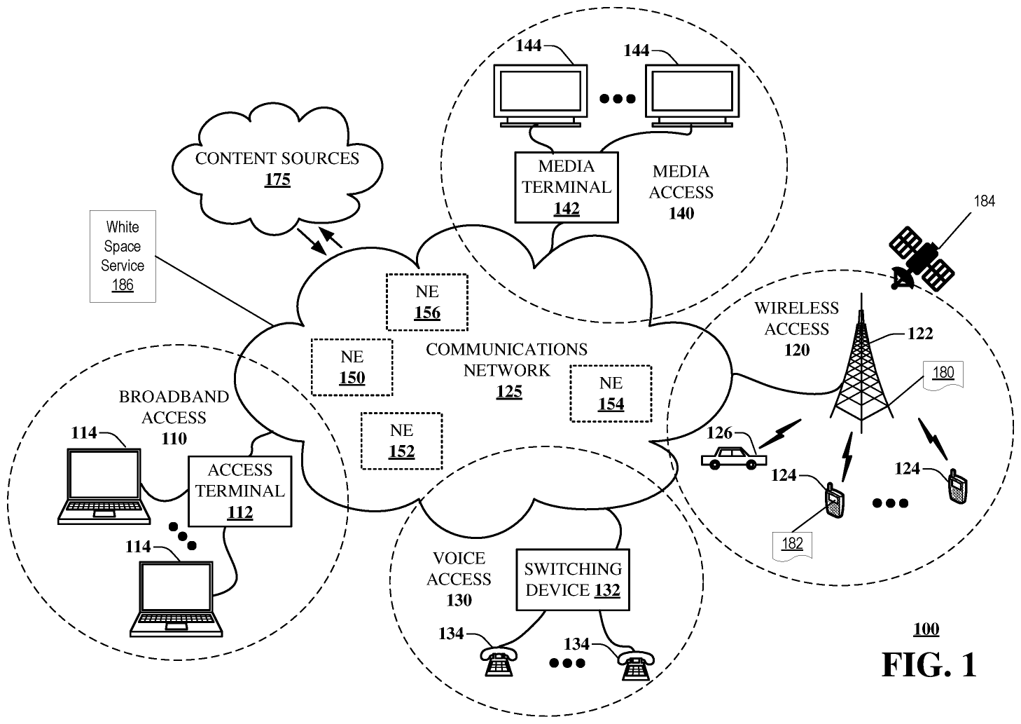

Referring now to FIG. 1, a block diagram is shown illustrating an example, non-limiting embodiment of a system 100 in accordance with various aspects described herein. For example, system 100 can facilitate in whole or in part, determining a mobile device is near a boundary of a first coverage region of a first mobile service provided by one of a terrestrial mobile service and a non-terrestrial mobile service and identifying a location a second coverage region of a second mobile service provided by another one of the terrestrial mobile service and the non-terrestrial mobile service, wherein the second coverage region is nearby the first coverage region. Persistent information is forwarded to the mobile device via the first mobile service, wherein the persistent information identifies a location of the second coverage region, and wherein the persistent information facilitates guidance of the mobile device toward the second coverage region. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc., for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc., can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

In at least some embodiments, the communication system 100 may include a terrestrial communication system providing cellular coverage in a first, terrestrial coverage region, e.g., according to the wireless access 120, and an alternative non-terrestrial communication system, e.g., a satellite communication system 184 that may provide cellular coverage in a second, non-terrestrial coverage region. It is understood that the first and second coverage regions may be isolated, at least in part, establishing a whitespace therebetween in which service may be inaccessible according to either the wireless access 120 or the satellite communication system 184.

In at least some embodiments, one of the wireless access 120, e.g., the base station 122, the satellite communication system 184, or both may include edge detection and/or guidance support functionality, such as any of the various examples disclosed herein, to provide a mobile communication device, e.g., the UE 124, with notifications regarding a service coverage edge and/or guidance to an alternative one of the wireless access 120 or the satellite communication system 184. In at least some embodiments, functionality related to edge detection and/or guidance may be provided by guidance functionality 180 at the base station, guidance functionality at one or more backend servers 186, guidance functionality 182 within the UE 124 or any combination thereof.

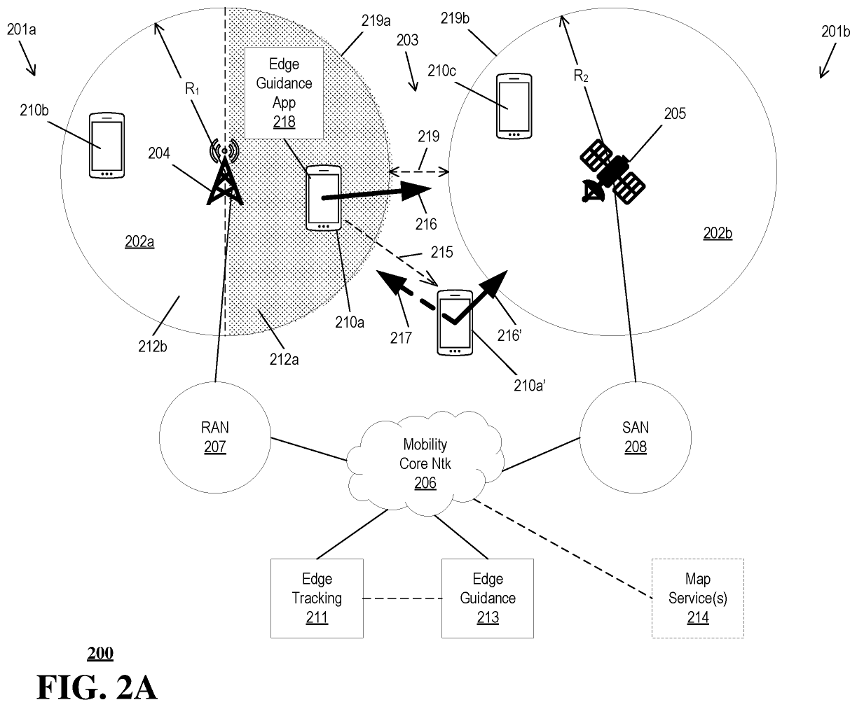

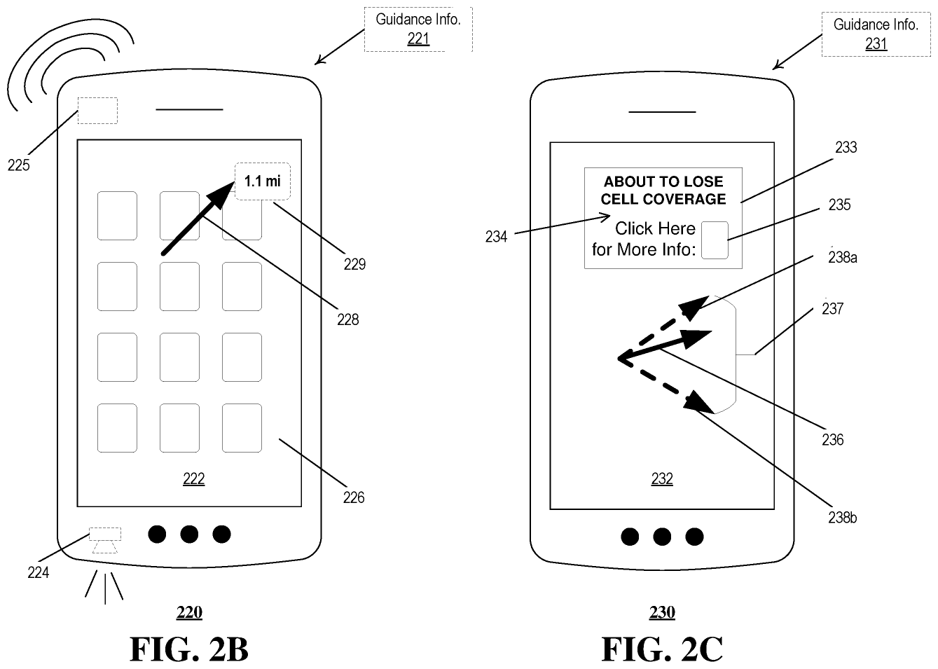

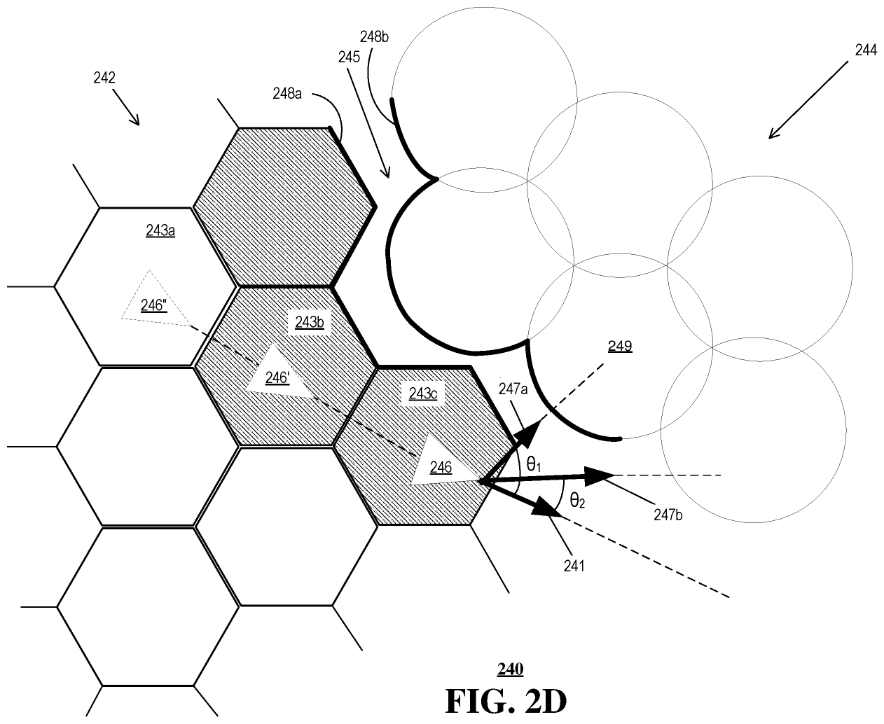

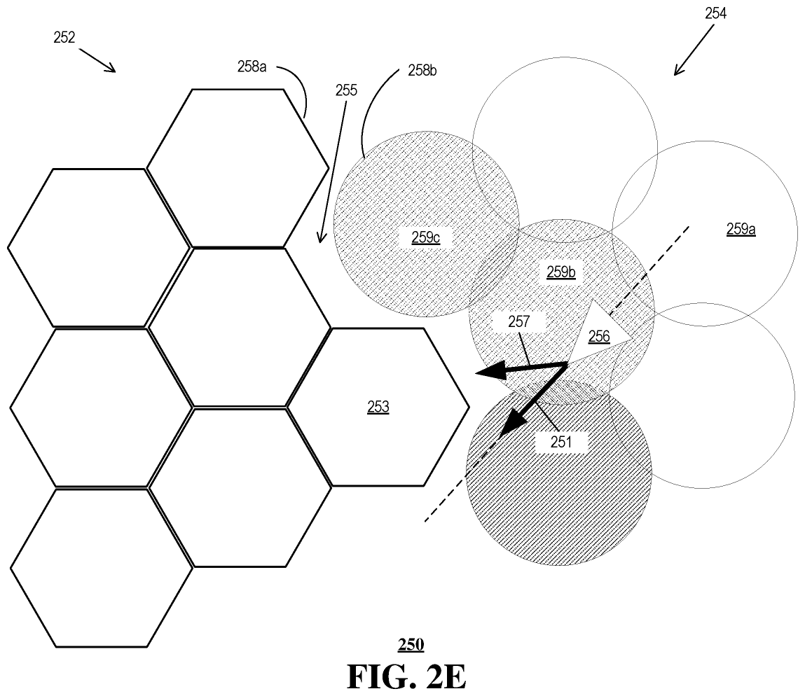

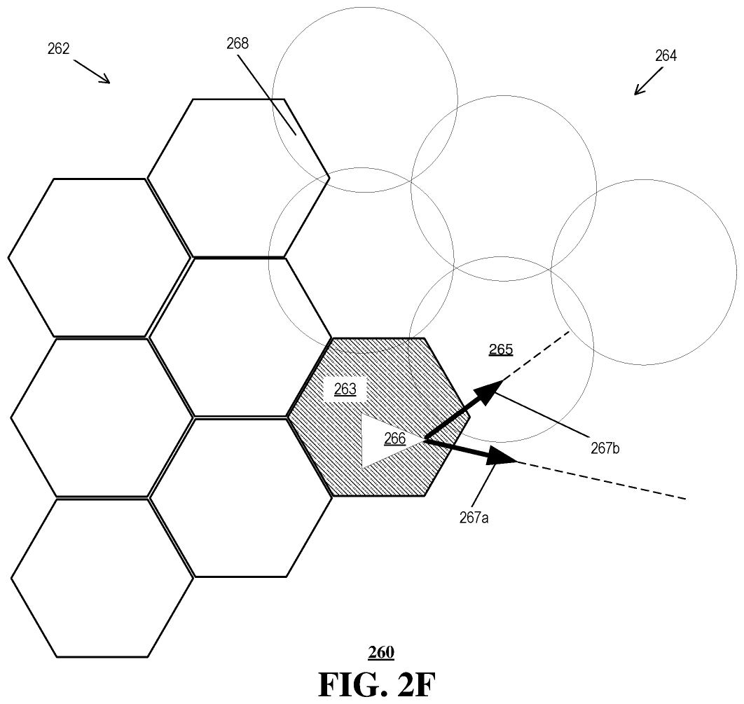

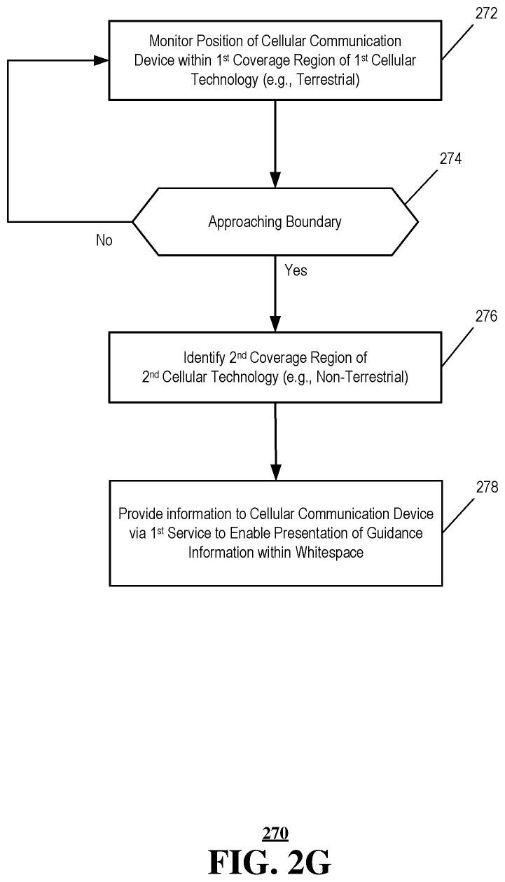

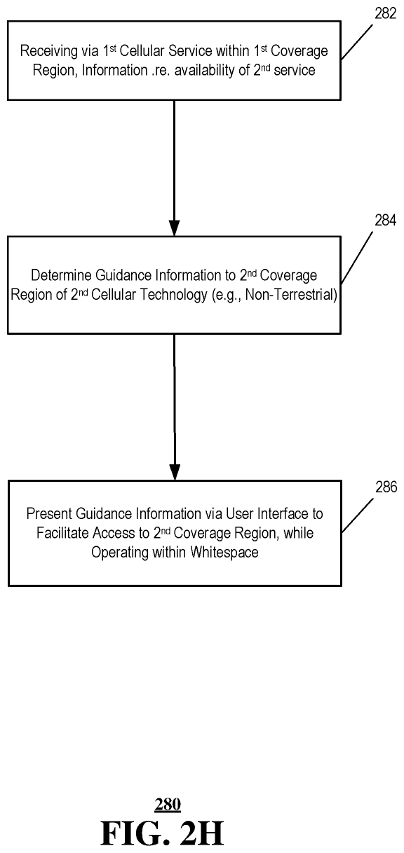

FIG. 2A is a block diagram illustrating an example, non-limiting embodiment of a whitespace guidance system 200 functioning within the communication system 100 of FIG. 1 in accordance with various aspects described herein. The example whitespace guidance system 200 includes a terrestrial cellular communication system 201a providing a first cellular service within a first cellular coverage region 202a and a non-terrestrial cellular communication system 201b providing a second cellular service within a second cellular coverage region 202b. It is understood that in at least some embodiments, at least a portion of the first and second cellular coverage regions 202a, 202b may overlap along a boundary or transition region. Alternatively, or in addition, the first and second cellular coverage regions 202a, 202b may be isolated and/or separated from each other resulting in an area or region between the first and second cellular coverage regions 202a, 202b that is not serviced by either the terrestrial cellular communication system 201a or the non-terrestrial cellular communication system 201b. In at least some instances, an area or region lacking cellular service from either the terrestrial cellular communication system 201a or the non-terrestrial cellular communication system 201b may be referred to as a whitespace region 203.

According to the illustrative example, the first cellular service is provided by a terrestrial base station 204 that provides a first cellular communication service over in one or more sectors defining at least a portion of the first cellular coverage region 202a. The first cellular coverage region 202a is illustrated as an approximate circle, centered around a location of the terrestrial base station 204 and defining a first boundary 219a, i.e., a perimeter, approximating a maximum range and/or extent of the first cellular coverage region 202a beyond which the first cellular service maybe inaccessible and/or unreliable. It is understood that the first cellular coverage region 202a may exhibit other shapes and/or sizes as may be determined by a configuration of cellular base stations, cells and/or sectors. The first cellular coverage region 202a may be defined by cells having differing ranges and/or areas alone or in combination with other terrestrial base stations providing respective coverage areas that collectively form a first contiguous coverage region referred to herein as the first cellular coverage region 202a.

Further according to the illustrative example, the second cellular service is provided by a satellite communication system 205 that provides a second cellular communication service, e.g., via one or more satellite beams, e.g., spot beams, defining at least a portion of the second cellular coverage region 202b. The second cellular coverage region 202b is illustrated as an approximate circle, centered around a location of a center of a spot beam and defining a second boundary 219b, i.e., a perimeter, approximating a maximum range and/or extent of the second cellular coverage region 202b beyond which the second cellular service maybe inaccessible and/or unreliable. It is understood that the second cellular coverage region 202b may exhibit other shapes and/or sizes as may be determined by satellite beams having differing ranges, sizes, shapes and/or areas and/or including satellite beams provided by the same satellite and/or spot beams provided by other satellites providing respective coverage areas that collectively form a second contiguous coverage region referred to herein as the second cellular coverage region 202b.

One or more of the terrestrial base stations 204 that individually and/or collectively support the first cellular coverage region 202a maybe in communication with a central or core network, referred to herein as a mobility core network 206, via a terrestrial access network, such as a radio access network (RAN) 207. Likewise, one or more of the non-terrestrial terminals, e.g., the satellite communication system 205, that individually and/or collectively support the second cellular coverage region 202b maybe in communication with the mobility core network 206 via a non-terrestrial access network, such as a satellite access network (SAN) 208.

In at least some embodiments, the whitespace guidance system 200 may include one or more of an edge tracking subsystem 211 and/or an edge guidance subsystem 212. The edge tracking subsystem 211 may be configured to identify wireless communication devices that are close to and/or within an edge region or edge zone of the first cellular coverage region 202a, such as an example first mobile communication device 210a. Here, the first mobile communication device 210a is operating within the first cellular coverage region 202a, which borders the whitespace region 203. The edge region may include one or more terrestrial cells and/or sectors that border the whitespace region 203. Alternatively, or in addition, the edge region may include one or more portions of one or more terrestrial cells and/or sectors. In at least some embodiments, a cell and/or sector may be subdivided to distinguish coverage regions proximate to the whitespace region 203 from other coverage regions. For example, an outer region of a cell and/or sector, as may be distinguished by a range, e.g., beyond some distance threshold, may be identified as at least a portion of the edge region. Alternatively, or in addition, a cell and/or a sector may be further subdivided, e.g., to distinguish those cellular coverage areas proximate to the whitespace region 203 from other cellular coverage areas.

By way of example, the circular first cellular coverage region 202a may be subdivided into two sub-regions, e.g., halves, to define a first sub-region 212a proximal to the whitespace region 203 and a second sub-region 212b distal to the whitespace region 203. Here the first mobile communication device 210a is located within the first sub-region 212a, which is proximate to the whitespace region 203. Accordingly, the first mobile communication device 210a may be characterized and/or otherwise identified as residing and/or operating within an edge region. In other instances, the entire first cellular coverage region 202a may be identified as an edge region based on its proximity to the second cellular coverage region 202b, the whitespace region 203 or any combination of the second cellular coverage region 202b and the whitespace region 203. According to the illustrative example, a second mobile communication device 210b is located in the second sub-region 212b. Accordingly, the second mobile communication device 210b may not be characterized and/or otherwise identified as residing in the edge region, whereas the first mobile communication device 210a would be characterized as residing in the edge region, i.e., the first sub-region 212a.

Although the illustrative example contemplates providing whitespace guidance to mobile communication devices 210a, 210b, generally 210, present within the first cellular coverage region 202a, it is understood that, alternatively, or in addition, the whitespace guidance system 200 may provide whitespace guidance to mobile communication devices, e.g., a third mobile communication device 210c present within the second cellular coverage region 202b. Accordingly, the concepts of edge zones or regions may be applied to one or more of the satellite coverage regions, e.g., spot beams, in while or in part.

The edge tracking subsystem 211 may be in communication with one or more of the terrestrial base station 204, the non-terrestrial base station, e.g., the satellite communication system 205, the RAN 207, the SAN 208, the mobility core network 206 and the mobile communication devices 210a, 210b, 210c, generally 210. Although a single mobility core network 206 is identified in the illustrative example, it is understood that in at least some embodiments, the satellite communication system 205 may manage the second cellular service via another mobility core network (not shown), e.g., with a communication channel to the mobility core network 206 to facilitate interoperability, e.g., handovers, therebetween.

In at least some embodiments, the edge tracking system 211 may detect a location and/or presence of mobile communication devices 210 within an edge region according to a static location of the mobile communication device 210. For example, the edge tracking system 211 may receive location information indicative of an approximate location of the mobile communication device 210. The location information may include, without limitation, geolocation coordinates, a map location, proximity to the terrestrial base station 204 and/or spot beam of the satellite communication system 205. The edge tracking system 211 may compare the location to predetermined locations of edge regions to detect and/or otherwise determine that a mobile communication devices 210 is within the edge region. Alternatively, or in addition, the edge tracking system 211 may associate a location of a mobile communication device 210 with an edge region according to the attached terrestrial base station 204 and/or sector, the attached spot beam of the satellite communication system 205 or any combination thereof.

In some embodiments, location information may be reported to the edge tracking system 211 by one or more of the first cellular service and the second cellular service. For example, the first cellular service may determine an approximate location of the mobile communication device 210 according to a current and/or recent cell and/or sector connectivity, triangulation, and/or as reported by the mobile communication devices 210. Alternatively, or in addition, the second cellular service may determine an approximate location of the mobile communication device 210 according to a current and/or recent beam, e.g., spot beam, connectivity, triangulation, and/or as reported by the mobile communication devices 210.

In at least some embodiments, the edge tracking system 211 may detect a location and/or presence of mobile communication devices 210 within an edge region according to a direction of movement and/or rate of speed of the mobile communication device 210. For example, the edge tracking system 211 may receive a time sequence of location information indicative of current and/or recent locations of the mobile communication device 210. The time sequence of location information may be processed by one or more of the edge tracking system 211, equipment of the first cellular service, equipment of the second cellular service, the mobile devices, or any combination thereof. The edge tracking system 211 may determine one or more of a location, a direction, heading or bearing, a speed and/or velocity and/or acceleration. The edge tracking system 211 may compare one or more of the location, the direction, heading or bearing, a speed, velocity and/or acceleration to predetermined locations of edge regions to detect and/or otherwise determine that a mobile communication devices 210 is within and/or approaching an edge region. In at least some embodiments, an edge region may be effectively expanded based on a speed, velocity and/or acceleration of a device.

In at least some embodiments, stationary and/or static wireless communication devices, such as home and/or office systems, municipal systems, industrial systems, Internet of Things (IoT) devices and so on may be distinguished from non-stationary wireless communication devices, such as mobile devices, such as smart phones, smart watches, tablet devices, laptop computers, smart vehicles, drones, robots, etc. In at least some embodiments, the extent that the stationary wireless communication devices may be excluded from consideration by one or more of the edge tracking system 211 and an edge guidance system.

In at least some embodiments, the whitespace guidance system 200 is configured to provide guidance information to mobile communication devices 210 to facilitate transitions between a first coverage region providing terrestrial cellular service and a second coverage regions providing non-terrestrial cellular service. In at least some embodiments, the guidance information is provided to a mobile communication device 210 while operating within one of the first and second coverage regions to provision the mobile communication device 210 with guidance information adapted to facilitate locating, accessing and/or otherwise establishing cellular service with another one of the first and second coverage regions. This may include provisioning the mobile communication device 210 with information that remains accessible and/or otherwise useful to the mobile communication device 210 while traversing a whitespace region 203 and/or prior to attachment to the other one of the first and second coverage regions.

Without limitation, the guidance information may include one or more of a direction, heading or bearing toward the other one of the first and second coverage regions, and/or a distance to and/or estimated time of arrival at the other one of the first and second coverage regions. It is understood that the guidance information received by the mobile communication device 210 may be accessed, manipulated, updated, and/or utilized by information provided by the mobile communication device 210, e.g., to provide updates and/or adjustments to one or more of a direction, heading or bearing toward the other one of the first and second coverage regions, and/or a distance to and/or estimated time of arrival at the other one of the first and second coverage regions. For example, a compass style direction may be determined based on a last reported location of the other one of the first and second coverage regions and an updated location and/or direction, bearing or heading of the mobile communication device 210. The compass style direction may point toward the other one of the first and second coverage regions, e.g., along a shortest path to coverage. Accordingly, the mobile communication device 210 may use and/or otherwise adapt the guidance information to establish revised guidance information that may be used by the mobile communication device 210 to reach and/or otherwise access and/or establish cellular service via the other one of the first and second coverage regions.

According to the illustrative example, the first mobile communication device 210a may be accessing the first cellular service while operating at a first location within the first sub-region 212a. A location of the first mobile communication device 210a may be determined by and/or otherwise reported to the edge tracking subsystem, which, in turn, may determine that the first mobile communication device 210a is operating within an edge region, i.e., the first sub-region 212a. The edge tracking system 211 may provide a notification and/or information that results in the edge guidance subsystem 213 calculating, determining and/or otherwise providing guidance information. The notification and/or information may include one or more of a location, direction, heading or bearing, a speed, velocity and/or acceleration of the first mobile communication device 210a and, in at least some embodiments, an indication that the first mobile communication device 210a is within the edge region. The guidance information may include, without limitation, one or more of a direction, heading or bearing, a distance to and/or estimated time of arrival at the other one of the first and second coverage regions.

In at least some embodiments, the edge guidance subsystem 213 provides the guidance information to the first mobile communication device 210a via the one of the first and/or second cellular communication services to which the first mobile communication device 210a is attached. According to the illustrative example, the first mobile communication device 210a may receive a notification that it is operating within an edge region and that another cellular service provided via a different technology is available according to an indicated direction 216. Alternatively, or in addition, the notification may include further guidance information indicating a distance to and/or estimated time of arrival at the other cellular service.

Further according to the illustrative example, the first mobile communication device 210a is moving along a trajectory 215. To the extent that the first mobile communication device 210a does not deviate from the trajectory 215, it will not intersect the other cellular service. At a later time, the first mobile communication device 210a′ is illustrated at a second location along the trajectory 215, which places the first mobile communication device 210a′ within the whitespace region 203. The first mobile communication device 210a′ may utilize guidance information provided by the edge guidance subsystem 213 alone or in combination with information provided by the first mobile communication device 210a, e.g., an updated geolocation and/or map location, to obtain updated guidance information. According to the illustrative example, the updated guidance information to update an indication that a different technology is available according to an updated indicated direction 216′. In at least some embodiments, the guidance information may include an indication, e.g., a direction, heading or bearing, a distance to and/or an estimated time of arrival at a last operative cellular communication service, e.g., providing an alternative to return to a region offering the original cellular service. Here, the first mobile communication device 210a′ may indicate at least two compass-style indications, a first indication 216′ to the alternative cellular technology and a second indication 217 toward the last operative cellular coverage region.

In at least some embodiments, the whitespace guidance system 200 may include a map service subsystem 214. The map service subsystem 214 may provide map information that may include one or more of cellular service coverage maps, non-terrestrial service coverage maps, e.g., spot beam locations, terrain maps, road maps, municipal maps showing buildings and other architectural structures. Map-related information may be used by the edge tracking system 211, e.g., to identify mobile communication devices 210 within an edge region. Alternatively, or in addition, the map-related information may be used by the edge guidance subsystem 213, e.g., to identify guidance information to one or more alternative cellular services and/or cellular service locations.

It is envisioned that in at least some embodiments, the map-related information may be used by one or more of the edge tracking system 211, the edge guidance subsystem 213 and/or the edge guidance application 218 to determine a nature of a notification and/or guidance information. For example, a mobile communication device 210 operating on a roadway, may benefit from a notification and/or guidance information regarding an edge of coverage and/or alternative available cellular coverage according to map routing information. This may include sufficient lead time to provide a traveler with notice and/or options in a timely manner so as not to miss opportunities to access an alternate cellular service and/or to avoid backtracking as may be necessary without having suitable notice. Map information may include and/or otherwise take into account other information, such as reported hazards, traffic, tolls, and so on.

FIG. 2B is a block diagram illustrating an example, non-limiting embodiment of a mobile device 220 configured according to a whitespace guidance system functioning within the communication system 100 of FIG. 1 in accordance with various aspects described herein. According to the illustrative example, the mobile device 220 is presented as a smart phone that provides one or more user interface (UI) modes. The UI modes include, without limitation, a visual UI, e.g., a display 222, an audio UI, e.g., a speaker 224 and a haptic UI, e.g., a buzzer 225. One or more of the UI modes may be utilized to present information to a user regarding whitespace guidance.

In operation, the mobile device 220 may be configured to receive and/or otherwise modify and/or generate guidance information. The guidance information may be received via an exchange of messages with one or more of the equipment of a cellular service provider and/or a third-party system, e.g., a backend server. The received messages may include guidance information 221, e.g., obtained at least in part from the edge guidance subsystem 213 (FIG. 2A), and/or an indication that the mobile device 220 is present within an edge region, proximate to an edge region, about to enter an edge region and/or about to leave a cellular service region, e.g., obtained at least in part from the edge tracking subsystem 211. Alternatively, or in addition, the guidance information 221 may include an indication of the availability of another, possibly nearby cellular service. In at least some instances, an identification and/or indication of the other cellular service may include an indication that the cellular service is operated according to a different technology, such as one of a terrestrial cellular service or a non-terrestrial service.

For example, whitespace guidance information may be presented to inform a user that the mobile device 220 is in and/or about to enter an edge zone of a first type of cellular service, beyond which the first type of cellular service may not be accessible. Alternatively, or in addition, the whitespace guidance information may be presented to inform a user that the mobile device 220 may access a nearby second type of cellular service that differs from the first type of cellular service. For example, the first type of cellular service may include one of a terrestrial cellular service or a non-terrestrial cellular service, while the second type of cellular service may include a different one of the terrestrial cellular service or the non-terrestrial cellular service.

A presentation of the whitespace guidance information by the mobile device 220 may include any one of the display 222, the speaker 224, the buzzer 225, or any combination thereof. The display may present a direction, e.g., heading or bearing information adapted to direct the user to one of the first and second different types of cellular service. For example, a compass style arrow 228 may be presented at the display 222 of a mobile device operating within an edge region and/or within a whitespace region after exiting a first cellular service region, e.g., terrestrial cellular service. The compass style arrow 228 may provide direction to a nearby second cellular service region, e.g., satellite cellular service. In at least some embodiments, the compass style arrow 228 remains operable despite there being a lack of cellular service, e.g., while traversing a whitespace region. Such operability may be supported by location information, e.g., a geolocation and/or map location of a satellite spot beam offering cellular service otherwise accessible to the mobile device 220. For example, the persistent information may include a spot beam center and beamwidth and/or radius, which the mobile device 220 may use to compare to a location of the mobile device that may be obtained by the mobile device, e.g., using a geolocation receiver system and/or dead reckoning.

According to the illustrative example, the compass style arrow 228 may be displayed on top of another display screen 226, such as a lock screen, a home screen, an app screen and the like. Alternatively, or in addition, a presentation of the whitespace guidance information by the mobile device 220 may include other information, such as text, images, graphics, animation, an avatar, a video clip, and the like. The illustrative example includes a message area 229, which may be presented alone or in combination with the compass style arrow 228. The message area 229 may include text, e.g., indicating a range to and/or an estimated time of arrival (ETA) at the alternate cellular service represented by the compass style arrow 228. In determining an ETA, the mobile device 220 may determine a distance from a location of the mobile device 220 to the alternate cellular service along the suggested heading. The distance may be used together with an estimate of a speed of the mobile device to determine an ETA as a ratio of the distance to the speed.

Alternatively, or in addition, an audible alarm may sound via the speaker 224 and/or a vibration may be provided by the buzzer 225. A first alarm sound may indicate that the mobile device has entered or is about to enter an edge region. Alternatively, or in addition, a second alarm sound may indicate that the mobile device has entered or is about to enter a whitespace region. It is envisioned that other audible sounds, e.g., series of beeps or tones may be used to indicate a direction. For example, a user may move, e.g., turn or rotate, while holding the mobile device. For bearings or headings closer to a reported, determined and/or estimated direction to the alternate service as may be provide by and/or determined according to the guidance information 221, a pulse spacing and/or duty cycle may indicate a first pattern, e.g., closely spaced and/or relatively loud or strong beeps or sounds. Alternatively, for bearings or headings farther from a reported, determined and/or estimated direction to the alternate service, a pulse spacing and/or duty cycle may indicate a second pattern, e.g., widely spaced and/or relatively quiet or weak beeps or sounds. It is understood that a user may perform a location process by rotating the mobile device toward a preferred pattern of the sounds as an indication of a direction, heading or bearing to the alternate service. In at least some embodiments, one or more of the pulse rate, duty cycle and/or loudness may be adjusted according to an estimate of a range and/or an ETA to the alternate cellular service.

FIG. 2C is a block diagram illustrating an example, non-limiting embodiment of another mobile device 230 configured according to a whitespace guidance system functioning within the communication network of FIG. 1 in accordance with various aspects described herein. According to the illustrative example, the mobile device 230 is presented as a smart phone including a display, which may include a touchscreen display 232. In operation, the mobile device 230 may be configured to receive and/or otherwise modify and/or generate guidance information, e.g., via guidance messages 231. In at least some embodiments, the operating system and/or a resident application may facilitate processing and/or presentation of the guidance information. According to the illustrative example, a text message 233 may be displayed on a dedicated area 233, an overlay, e.g., a splash screen, of the touchscreen display 232 providing guidance related information and in at least some embodiments, including an input/output region 235, such as a button, drop down menu, e.g., which may be operable to display additional guidance related information.

Further according to the illustrative example, more than one guidance prompt, e.g., compass style arrows may be displayed sequentially, selectively, and/or contemporaneously. For example, a first compass style arrow 238a may point to a first edge of an accessible alternate cellular coverage region, e.g., along a tangent extending from the mobile device 230 to an upper edge of a spot beam. Likewise, a second compass style arrow 238b may point to a second edge of the accessible alternate cellular coverage region, e.g., along a tangent extending from the mobile device 230 to a lower edge of the spot beam. Alternatively, or in addition, a third compass style arrow 236 may point to a nearest edge and/or easiest accessible or reachable edge of the accessible alternate cellular coverage region, e.g., along a radial from the wireless device 230 to a center of the spot beam. One or more boundary regions, e.g., between the first and second compass style arrows 238a, 238b may form a wedge 237, which may be shaded and overlaid upon a map to facilitate identification of a map route from a location of the mobile device 230 to the alternate cellular coverage region.

FIG. 2D is a block diagram illustrating an example, non-limiting embodiment of a mobile device scenario 240 with guidance assist according to a whitespace guidance system functioning within the communication system 100 of FIG. 1 in accordance with various aspects described herein. The mobile device scenario 240 includes a terrestrial cellular coverage region 242, when which cellular service is provided by one or more terrestrial cells that may include adjacent terrestrial cells 243a, 243b, 243c forming a contiguous coverage region. The terrestrial cellular coverage region 242 extends to a first outer boundary or edge 248a beyond which there exists an area without cellular coverage, referred to herein as a whitespace region 245. In at least some embodiments, those terrestrial cells 243b, 243c defining the first outer boundary or edge 248a may be referred to as defining an edge region, i.e., the shaded region. The mobile device scenario 240 further includes a non-terrestrial cellular coverage region 244, when which cellular service is provided by one or more non-terrestrial cells 249. The non-terrestrial cellular coverage region 244 extends to a second outer boundary or edge 248b bordering the whitespace region 245.

In at least some embodiments, a terrestrial service provider managing reserved resources, e.g., licensed cellular spectrum, may allow other service providers to offer cellular service in what would otherwise be whitespace regions. In at least some embodiments, the other service providers may include non-terrestrial service providers that may provide cellular service according to a non-terrestrial cellular technology. Example non-terrestrial technologies include, without limitation, satellite based cellular service, lighter-than-air vehicle based cellular service, drone-based service, areal platform-based service and so on. In at least some embodiments, mobile communication devices adapted to access the terrestrial cellular service may be operable in areas of non-terrestrial service with little or no modification.

A first mobile communication device position 246″ is illustrated within a first terrestrial cell 243a, occurring at a first time, t₁. At a later time, t₂>t₁, a second mobile communication device position 246′ is illustrated at a second position located within a second terrestrial cell 243b. At an even later time, t₃>t₂, a third mobile communication device 246 is illustrated within a third terrestrial cell 243c. As the mobile communication device moves from the first position 246″ to the second position 246′, it enters an edge region including cellular coverage of a first terrestrial cell 243b defining at least a portion of an edge region. A trajectory of the mobile device does not suggest that the mobile communication device 246 will traverse the first outer boundary or edge 248a. Accordingly, the edge guidance subsystem 213 (FIG. 2A) may not provide guidance information, other than, perhaps, indicating that the mobile communication device is operating within the edge region.

As the mobile communication device moves from the second position 246′ to the third position 246, it remains within the edge region including cellular coverage of a second terrestrial cell 243b defining at least a portion of an edge region. However, in this instance, the trajectory at the third mobile device position 246 suggests that the mobile communication device 246 may traverse the first outer boundary or edge 248a. Accordingly, the edge guidance subsystem 213 may provide guidance information. The guidance information may provide a first arrow 247a pointing toward a shortest, e.g., most direct, route to the non-terrestrial cellular coverage region 244. Alternatively, or in addition, the guidance information may provide a second arrow 247b pointing toward another portion of the non-terrestrial cellular coverage region 244 that may be encountered at a direction having less variance from a third arrow indicating an original direction 241 of the mobile communication device. An operator may choose which arrow to follow, if any.

FIG. 2E is a block diagram illustrating an example, non-limiting embodiment of another mobile device scenario 250 with guidance assist operating according to a whitespace guidance system functioning within the communication system 100 of FIG. 1 in accordance with various aspects described herein. The mobile device scenario 250 includes a terrestrial cellular coverage region 252, within which cellular service is provided by one or more terrestrial cells that may include adjacent terrestrial cells 253 forming a contiguous coverage region. The terrestrial cellular coverage region 252 extends to a first outer boundary or edge 248a beyond which there exists an area without cellular coverage, referred to herein as a whitespace region 245. The mobile device scenario 250 further includes a non-terrestrial cellular coverage region 254, when which cellular service is provided by one or more non-terrestrial cells 259a, 259b, 259c, e.g., spot beams for satellite provided non-terrestrial cellular service. The non-terrestrial cellular coverage region 254 extends to a second outer boundary or edge 248b bordering the whitespace region 245. In at least some embodiments, those non-terrestrial cells 259b, 259c defining the second outer boundary or edge 258b may be referred to as defining an edge region, i.e., the shaded region.

A mobile communication device 256 is illustrated within an edge non-terrestrial cell 259b. According to the illustrative example, the mobile communication device 256 is moving along a direction represented by a trajectory arrow 251. The trajectory arrow 251 suggests that the mobile communication device 256 may traverse the second outer boundary or edge 248b. Should the mobile communication device 256 continue along according to the trajectory arrow 251, it would enter the whitespace region 255 and lose coverage. It would also not intersect the nearby terrestrial cellular coverage area 252. Accordingly, the edge guidance subsystem 213 (FIG. 2A) may provide guidance information to the mobile communication device 256. The guidance information may provide information in the form of the second arrow 257, or information allowing the mobile communication device 256 to determine the second arrow 257, e.g., by calculating a bearing angle based on the trajectory arrow 251 and information provided by the edge guidance system, e.g., a location of the terrestrial cellular coverage region 252.

Information provided by the edge guidance subsystem 213 may be provided via the non-terrestrial cellular service and retained by the mobile communication device 256 after it departs the non-terrestrial cellular coverage region 254, to permit the mobile communication device 256 to present guidance information, e.g., an indication of the second arrow 257 pointing toward the terrestrial cellular coverage region 252.

In some embodiments, guidance information is provided to the mobile communication device 256 responsive to a determination that the mobile communication device is operating within an edge region, or that the mobile communication device 256 is likely to exit the edge region, which will result in a loss of service via the non-terrestrial cellular coverage region 254. Alternatively, or in addition, the guidance information may be provided to the mobile communication device 256 after determining that the device is likely to exit the edge region, resulting in a loss of service and that movement along a most likely path, e.g., the trajectory arrow 251, will forego an opportunity to access a terrestrial service via a nearby terrestrial cellular coverage region 252.

FIG. 2F is a block diagram illustrating an example, non-limiting embodiment of yet another mobile device scenario 260 with guidance assist operating according to a whitespace guidance system functioning within the communication system 100 of FIG. 1 in accordance with various aspects described herein. According to the illustrative example, the terrestrial service region 262 overlaps at least a portion of non-terrestrial cellular coverage region 254, such that there may not exist a whitespace region. Nevertheless, there may remain a possibility that a mobile communication device 266 moving along a first trajectory 267a may forego an opportunity to access a nearby non-terrestrial service via a nearby non-terrestrial coverage region 264. In such instances, the edge guidance subsystem 213 (FIG. 2A) may provide guidance information to the mobile communication device 266 allowing the device to identify an alternative trajectory 267b that will guide the communication device to the overlapping non-terrestrial coverage cellular region 254.

It is understood that such overlapping coverage between the terrestrial and non-terrestrial services operating within the same allocated, e.g., licensed, spectrum may result in interference without special provisions. As such an overlapping configuration may be predetermined, it is understood that terrestrial service providers and non-terrestrial service providers may take precautions to reduce and/or avoid such occurrences of interferences to facilitate transitions of communication devices between services. At least one such measure involves utilization of reduced bandwidth paging. For example, cellular paging operations may utilize a coordinated paging process within the allocated frequency spectrum. For example, a portion of an allocated frequency spectrum dedicated to paging operations, BW_{Paging}, may be shared so as to allow paging by both the terrestrial service and the non-terrestrial service to occur withing the overlapping region of coverage 258. Such sharing arrangements may include temporal coordination and/or spectral coordination. For example, spectral coordination may utilize a reduced bandwidth paging, such that an allocated paging bandwidth BW_{Paging} may be assigned to each of the terrestrial, e.g., BW_{Paging_Terrestrial}, and non-terrestrial services, e.g., BW_{Paging_Non-Terrestrial}, allowing paging in both services to occur within an original allocated paging bandwidth. Namely:

BW_{Paging_Terrestrial}+BW_{Paging_Non-Terrestrial}BW_{Paging}≤BW_{Paging} Eq. 1

FIG. 2G depicts an illustrative embodiment of a mobile whitespace guidance process 270 in accordance with various aspects described herein. According to the example mobile whitespace guidance process 270, a position is monitored, at 272, of cellular communication device operating within a first coverage region and providing a first cellular service utilizing a first cellular technology. For example, the first cellular technology may be one of a terrestrial cellular technology or a non-terrestrial technology.

A determination is made, at 274, as to whether the cellular communication device is near an edge, boundary or extent of the first coverage region beyond which the first cellular service would no longer be available. To the extent it determined at 274 that the cellular communication device is not near and/or otherwise approaching the edge or boundary, the example mobile whitespace guidance process 270 returns to monitoring the position of the cellular communication device at 272. However, to the extent it is determined at 274 that the cellular communication device is near and/or otherwise approaching the edge or boundary, a second coverage region is identified at 276. The second coverage region provides a second cellular service utilizing a second cellular technology that differs from the first cellular technology. For example, the second cellular technology may be an alternative one of a terrestrial cellular technology or a non-terrestrial technology.

According to the example mobile whitespace guidance process 270, providing, at 278, information to the cellular communication device via the first cellular service. The persistent information enables a presentation of guidance information by the cellular communication device, while traversing and/or otherwise operating within a, so called, whitespace devoid of either the first cellular service or the second cellular service. It is understood that the information may include persistent information that remains available and/or otherwise accessible by the cellular communication device while in the whitespace. By way of example, the information may include a location of the second coverage region, a distance to an edge of the second coverage region, a direction or bearing to the second coverage region, an ETA to the edge of the second coverage region, and so on.

FIG. 2H depicts an illustrative embodiment of a mobile whitespace guidance process 280 in accordance with various aspects described herein. According to the example mobile whitespace guidance process 280, information regarding an availability of second cellular service is received, at 282, by a wireless communication device via a first cellular service provided within a first coverage region. Guidance information is determined, at 284, regarding access to a second cellular technology provided within a second coverage region. The first cellular service may be one of a terrestrial cellular service or a non-terrestrial cellular service, while the second cellular service is an alternate one of the terrestrial or non-terrestrial services.

In at least some embodiments, the determination is made, at least in part, by the wireless communication device. For example, guidance information may be provided by an edge tracking subsystem 211, an edge guidance subsystem 213, or a combination thereof. Guidance information may include any of the examples disclosed herein or otherwise known to those skilled in the art.

According to the example mobile whitespace guidance process 280, the guidance information and/or information based on the guidance information, may be presented at 286. For example, the guidance information may be provided via one or more user interfaces of the wireless communication device, e.g., to facilitate access to the second coverage region. In at least some embodiments, the guidance information remains persistent and in at least some embodiments may be updated, while the wireless communication device is operating within a whitespace region. Alternatively, or in addition, presentation of the guidance information, including updated guidance information when available, may be presented by one or more UI of the wireless communication device, even while operating within the whitespace region.

While for purposes of simplicity of explanation, the respective processes 270, 280 are shown and described as a series of blocks in FIGS. 2G and 2H, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

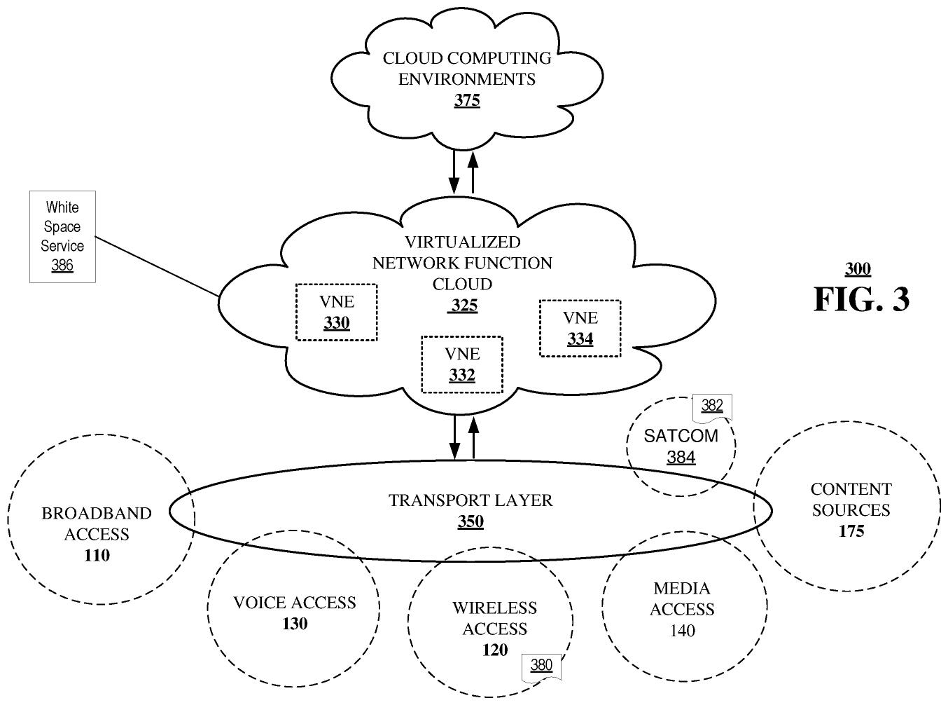

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of systems 200, 220, 230, the operational scenarios 240, 250, 260 and processes 270 and 280 presented in FIGS. 1, 2A, 2B, 2C, 2D, 2E, 2F, 2G, 2H and 3. For example, virtualized communication network 300 can facilitate in whole or in part determining a mobile device is near a boundary of a first coverage region of a first mobile service provided by one of a terrestrial mobile service and a non-terrestrial mobile service and identifying a location a second coverage region of a second mobile service provided by another one of the terrestrial mobile service and the non-terrestrial mobile service, wherein the second coverage region is nearby the first coverage region. Persistent information is forwarded to the mobile device via the first mobile service, wherein the persistent information identifies a location of the second coverage region, and wherein the persistent information facilitates guidance of the mobile device toward the second coverage region.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc., that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc., to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc., can be instantiated and managed using an orchestration approach similar to those used in cloud compute services.

The cloud computing environments 375 can interface with the virtualized network function cloud 325 via APIs that expose functional capabilities of the VNEs 330, 332, 334, etc., to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

In at least some embodiments, the virtualized communication network 300 may include a terrestrial communication system providing cellular coverage in a first, terrestrial coverage region, e.g., according to the wireless access 120, and an alternative non-terrestrial communication system, e.g., a satellite communication system 384 that may provide cellular coverage in a second, non-terrestrial coverage region. It is understood that the first and second coverage regions may be isolated, at least in part, establishing a whitespace therebetween in which service may be inaccessible according to either the wireless access 120 or the satellite communication system 384.

In at least some embodiments, one of the wireless access 320, the satellite communication system 384, or both may include edge detection and/or guidance support functionality, such as any of the various examples disclosed herein, to provide a mobile communication device with notifications regarding a service coverage edge and/or guidance to an alternative one of the wireless access 120 or the satellite communication system 384. In at least some embodiments, functionality related to edge detection and/or guidance may be provided by guidance functionality 380 at the wireless access 120, guidance functionality at one or more backend servers 386, guidance functionality 382 at the satellite communication system 384, or any combination thereof.

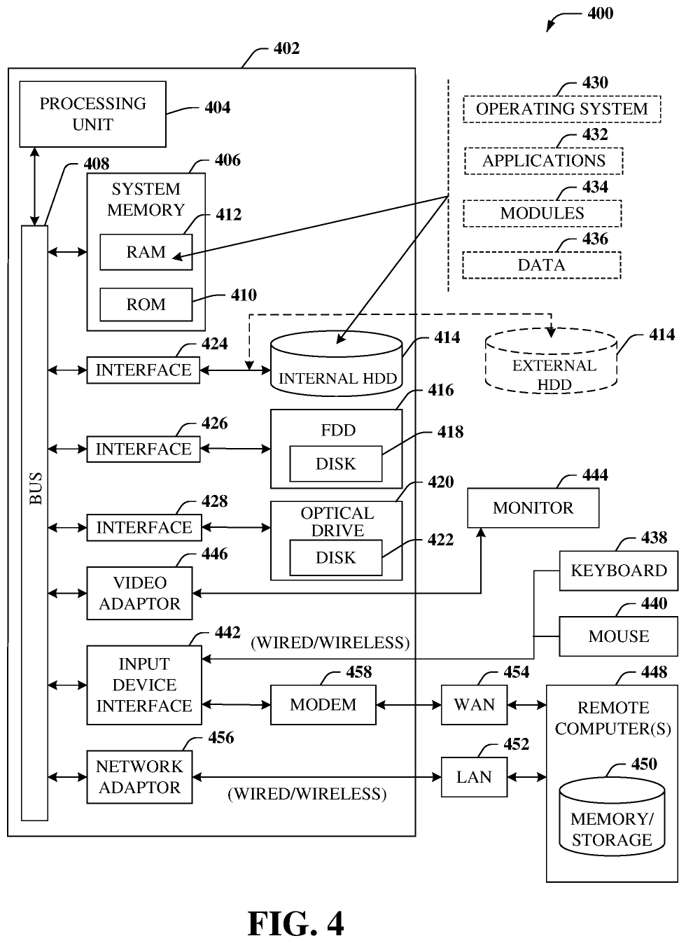

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part determining a mobile device is near a boundary of a first coverage region of a first mobile service provided by one of a terrestrial mobile service and a non-terrestrial mobile service and identifying a location a second coverage region of a second mobile service provided by another one of the terrestrial mobile service and the non-terrestrial mobile service, wherein the second coverage region is nearby the first coverage region. Persistent information is forwarded to the mobile device via the first mobile service, wherein the persistent information identifies a location of the second coverage region, and wherein the persistent information facilitates guidance of the mobile device toward the second coverage region.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

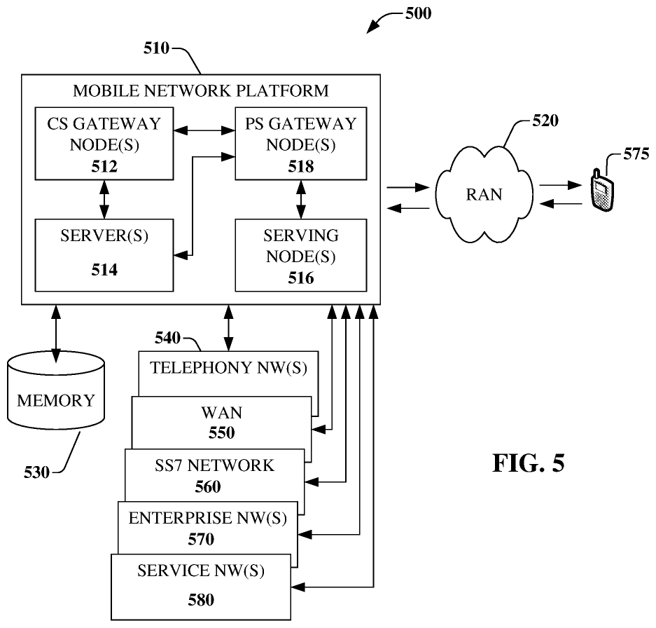

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part determining a mobile device is near a boundary of a first coverage region of a first mobile service provided by one of a terrestrial mobile service and a non-terrestrial mobile service and identifying a location a second coverage region of a second mobile service provided by another one of the terrestrial mobile service and the non-terrestrial mobile service, wherein the second coverage region is nearby the first coverage region. Persistent information is forwarded to the mobile device via the first mobile service, wherein the persistent information identifies a location of the second coverage region, and wherein the persistent information facilitates guidance of the mobile device toward the second coverage region. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc., that perform particular tasks and/or implement particular abstract data types.

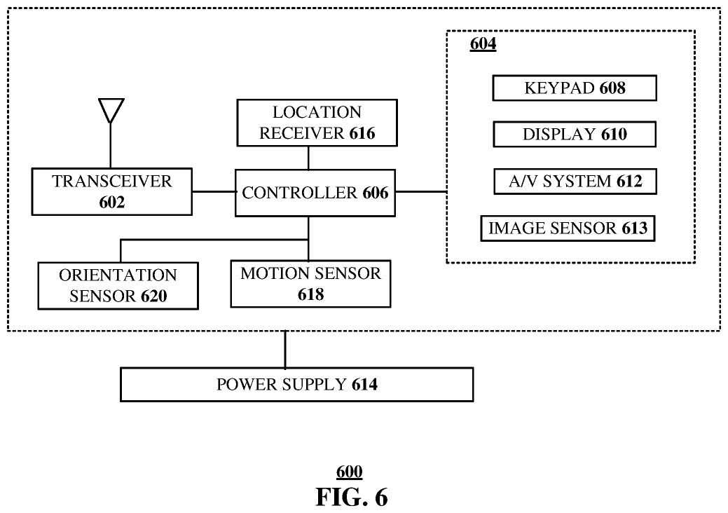

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part determining a mobile device is near a boundary of a first coverage region of a first mobile service provided by one of a terrestrial mobile service and a non-terrestrial mobile service and identifying a location a second coverage region of a second mobile service provided by another one of the terrestrial mobile service and the non-terrestrial mobile service, wherein the second coverage region is nearby the first coverage region. Persistent information is forwarded to the mobile device via the first mobile service, wherein the persistent information identifies a location of the second coverage region, and wherein the persistent information facilitates guidance of the mobile device toward the second coverage region.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
detecting, by a processing system including a processor, a cellular communication device approaching a boundary of a first coverage region of a first cellular service provided by one of a terrestrial cellular service and a non-terrestrial cellular service;
identifying, by the processing system, a second coverage region of a second cellular service provided by an alternative one of the terrestrial cellular service and the non-terrestrial cellular service, wherein the second coverage region is proximate to the first coverage region; and
transmitting, by the processing system, persistent information to the cellular communication device via the first cellular service, wherein the persistent information identifies a location of the second coverage region, and wherein the persistent information enables guidance of the cellular communication device in areas beyond the first coverage region.

2. The method of claim 1, wherein the first cellular service and the second cellular service operate within a common, allocated frequency band.

3. The method of claim 2, wherein the non-terrestrial cellular service comprises a satellite service.

4. The method of claim 2, wherein the first cellular service and the second cellular service comprise a 5G cellular service.

5. The method of claim 1, wherein the first coverage region of the first cellular service is separated from the second coverage region of the second cellular service by a whitespace region serviced by neither the first coverage region of the first cellular service nor the second coverage region of the second cellular service.

6. The method of claim 5, wherein the persistent information enables the guidance of the cellular communication device within the whitespace region towards the second coverage region.

7. The method of claim 1, wherein the persistent information comprises a location of the second coverage region of the second cellular service.

8. The method of claim 7, wherein the location of the second coverage region comprises a proximate boundary of the second coverage region.

9. The method of claim 1, wherein the detecting the cellular communication device approaching the boundary of the first coverage region further comprises:
detecting, by the processing system, a presence of the cellular communication device within an edge region of the first coverage region of a first cellular service.

10. The method of claim 1, wherein the detecting the cellular communication device approaching the boundary of the first coverage region further comprises:
detecting, by the processing system, a direction of movement of the cellular communication device;
estimating, by the processing system and according to the direction of movement, a future location of the cellular communication device; and
determining, by the processing system, the future location extends beyond the first coverage region of a first cellular service.

11. The method of claim 1, wherein the persistent information comprises an estimate of one of a distance to the second coverage region of the second cellular service, a time of arrival at the second coverage region of the second cellular service, or any combination thereof.

12. A device, comprising:
a processing system including a processor; and
a memory that stores executable instructions that, when executed by the processing system, facilitate performance of operations, the operations comprising:
estimating a wireless communication device is approaching a boundary of a first coverage region of a first wireless service provided by one of a terrestrial wireless service and a non-terrestrial wireless service;
identifying a second coverage region of a second wireless service provided by an alternative one of the terrestrial wireless service and the non-terrestrial wireless service, wherein the second coverage region is proximate to the first coverage region; and
forwarding persistent information to the wireless communication device via the first wireless service, wherein the persistent information identifies a location of the second coverage region, and wherein the persistent information enables guidance of the wireless communication device in areas beyond the first coverage region.

13. The device of claim 12, wherein the operations further comprise:
providing a notification to the wireless communication device via the first wireless service, wherein the notification indicates the wireless communication device is approaching a boundary of a first coverage region of a first wireless service.

14. The device of claim 13, wherein the notification further comprises a direction associated with a location of the second coverage region of the second wireless service.

15. The device of claim 14, wherein the operations further comprise:
determining an approximate location of the wireless communication device on a map; and
identifying a route toward the location of the second coverage region of the second wireless service, wherein the notification further comprises identification of the route.

16. The device of claim 12, wherein the persistent information further comprises a location of the first coverage region.

17. The device of claim 12, wherein the persistent information comprises an estimate of one of a distance to the second coverage region of the second wireless service, a time of arrival at the second coverage region of the second wireless service, or any combination thereof.

18. A non-transitory, machine-readable medium, comprising executable instructions that, when executed by a processing system including a processor, facilitate performance of operations, the operations comprising:
determining a mobile device is proximate to a boundary of a first coverage region of a first mobile service provided by one of a terrestrial mobile service and a non-terrestrial mobile service;
identifying a location of second coverage region of a second mobile service provided by an alternative one of the terrestrial mobile service and the non-terrestrial mobile service, wherein the second coverage region is proximate to the first coverage region; and
forwarding persistent information to the mobile device via the first mobile service, wherein the persistent information identifies a location of the second coverage region, and wherein the persistent information facilitates guidance of the mobile device toward the second coverage region.

19. The non-transitory, machine-readable medium of claim 18, wherein the operations further comprise:
providing a notification to the mobile device via the first mobile service, wherein the notification indicates the mobile device is approaching a boundary of a first coverage region of a first mobile service.

20. The non-transitory, machine-readable medium of claim 19, wherein the notification further comprises a direction associated with a location of the second coverage region of the second mobile service.
